(19) United States
(12) Patent Application Publication
(10) Pub. No.: US 2026/0219978 A1
(43) Pub. Date: Jul. 30, 2026

(54) IDENTIFYING ROOT CAUSE OF ABNORMAL INDICATORS IN OPERATIONAL DATA COLLECTOR

(71) Applicant: International Business Machines Corporation, Armonk, NY (US)

(72) Inventors: Yu Long Zhang, Beijing (CN); Mai Zeng, Beijing (CN); Ji Dong Li, Beijing (CN); Peng Hui Jiang, Beijing (CN)

(21) Appl. No.: 19/040,029

(22) Filed: Jan. 29, 2025

(51) Int. Cl. G06F 11/07

(52) U.S. Cl. CPC G06F 11/079; G06F 11/0709; G06F 11/0793

(57) ABSTRACT

A computer-implemented method, system, and computer program product for identifying root causes of abnormal indicators in operational data collectors. An error message or a prediction of an error message pertaining to an abnormal indicator is received. Log information from a component of the operational data collector associated with the error message is then received and transformed into a data structure using the joint entropy of information theory. Furthermore, troubleshooting data, which includes reasons for causing abnormal indicators and solutions for addressing abnormal indicators, is received. A graph (“knowledge graph”) is then generated from the troubleshooting data using a knowledge graph algorithm to model the data. Furthermore, a root cause of the abnormal indicator is identified using the data structure of the log information and the knowledge graph. A recovery command associated with the identified root cause of the abnormal indicator is then retrieved from a repository and implemented.

### TECHNICAL FIELD

The present disclosure relates generally to operational data collectors, and more particularly to accurately and quickly identifying the root cause of abnormal indicators in the operational data collector.

### BACKGROUND

Operational data collectors gather and stream operational data from a system (e.g., z/OS® system) to various analytics platforms. One example of an operational data collector corresponds to IBM Z® Common Data Provider (ZCDP).

### SUMMARY

In one embodiment of the present disclosure, a computer-implemented method for identifying root causes of abnormal indicators in operational data collectors comprises receiving an error message or a prediction of an error message pertaining to an abnormal indicator. The method further comprises receiving log information from a component of an operational data collector associated with the error message. The method additionally comprises transforming the log information into a data structure using joint entropy of information theory. Furthermore, the method comprises receiving troubleshooting data, including reasons for abnormal indicators, listing of abnormal indicators, and solutions for addressing abnormal indicators. Additionally, the method comprises generating a graph from the troubleshooting data using a knowledge graph algorithm to model data. In addition, the method comprises identifying a root cause of the abnormal indicator using the data structure of log information and the graph. The method further comprises retrieving and implementing a recovery command associated with the identified root cause of the abnormal indicator.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates an embodiment of the present disclosure of a computing environment for practicing the principles of the present disclosure;

FIG. 2 illustrates a system architecture for accurately and quickly identifying the root cause of abnormal indicators in the operational data collector in accordance with an embodiment of the present disclosure;

FIG. 3 illustrates using the joint entropy of information theory to streamline, vectorize, and transform log information into a data structure in accordance with an embodiment of the present disclosure;

FIG. 4 illustrates modeling based on troubleshooting data in accordance with an embodiment of the present disclosure;

FIG. 5 illustrates identifying the root cause of the abnormal indicator using the data structure of the log information and the troubleshooting graph in accordance with an embodiment of the present disclosure;

FIG. 6 is a flowchart of a method for predicting the future health status of the components in the operational data collector in accordance with an embodiment of the present disclosure; and

FIGS. 7A-7B are a flowchart of a method for accurately and quickly identifying the root cause of abnormal indicators in the operational data collector in accordance with an embodiment of the present disclosure.

### DETAILED DESCRIPTION

As stated above, operational data collectors gather and stream operational data from a system (e.g., z/OS® system) to various analytics platforms. One example of an operational data collector corresponds to IBM Z® Common Data Provider (ZCDP).

ZCDP is a tool that collects, filters, and formats information technology (IT) operational data from z/OS® systems and streams it to analytics platforms. ZCDP can collect a variety of data types, including, but not limited to, System Management Facilities (SMF) data, IBM® Information Management System (IMS) logs, SYSLOG (z/OS® system log), and other z/OS® logs, such as job logs (file that records a job's execution details, including the commands used in the job, the start and end times of the job, any error messages or failure notices, system messages from the batch container, output from the job executables, etc.), and application logs (records created by software applications during their runtime, capturing details about events, user interactions, system errors, and other activities within the application).

ZCDP can stream data to a number of destinations, including, but not limited to, IBM Z® Operations Analytics, Logstash® (Elasticsearch®), and Splunk®.

ZCDP can collect data once and provide it to multiple subscribers, which can be analytic solutions. It can also filter data to target specific use cases and reduce data volumes.

ZCDP contains many components performing various different functions, such as the system data engine (SDE), which is responsible for collecting operational data from various z/OS® systems, including system logs, performance metrics, and other relevant data sources. Another component of ZCDP is the data streamer (DS), which streams data from the data gatherers to configured subscribers in the appropriate format.

During the operation of the ZCDP, an error message may be generated from an abnormal indicator. An indicator refers to a specific metric or status flag that displays information about the process being performed by the ZCDP, such as the data collection process. For example, indicators may indicate the number of records gathered, the data streaming rate, potential errors encountered, overall heath of the data stream being sent to a designated analytics platform, etc. At times, such indicators are “abnormal.” An abnormal indicator refers to an abnormal situation being detected, where an abnormal situation refers to a condition that significantly deviates from its expected or “normal” operating behavior. The result of an abnormal indicator is the issuance of an error message. Examples of causes of such error messages include an SDE that is broken, an SDE that did not receive data, the failure in starting up an SDE, etc.

Unfortunately, it is difficult to identify the root cause of an abnormal indicator in the operational data collector. Examples of root causes of abnormal indicators include network abnormalities, processor overload, errors in the components, delays in sending data, etc., which takes developers a long time to identify such root causes. For instance, in order to identify the root cause of an abnormal indicator in the operational data collector, one needs to troubleshoot component by component of the ZCDP involved in the process. Furthermore, the logs (record of activities, operations, and usage patterns) of such components need to be analyzed which is a very complex and difficult process.

Consequently, it is difficult to accurately and quickly identify the root cause for such abnormal indicators in the operational data collector, such as the ZCDP.

The embodiments of the present disclosure provide a means for accurately and quickly identifying the root cause for abnormal indicators in the operational data collector, such as the ZCDP. In one embodiment, log information from a component of an operational data collector that is associated with an error message pertaining to an abnormal indicator is received. An indicator, as used herein, refers to a specific metric or status flag that displays information about the process being performed by the operational data collector, such as the data collection process. For example, indicators may indicate the number of records gathered, the data streaming rate, potential errors encountered, overall heath of the data stream being sent to a designated analytics platform, etc. At times, such indicators are “abnormal.” An abnormal indicator, as used herein, refers to an abnormal situation being detected, where an abnormal situation refers to a condition that significantly deviates from its expected or “normal” operating behavior. The result of an abnormal indicator is the issuance of an error message. An error message, as used herein, refers to a notification, such as to a user, regarding a problem that has occurred, such as with respect to a component of the operational data collector which triggered the abnormal indicator. Examples of causes of such error messages include an SDE that is broken, an SDE that did not receive data, the failure in starting up an SDE, etc. The log information is then transformed into a data structure using joint entropy of information theory. In information theory, “joint entropy” refers to a measure of the total uncertainty associated with two or more random variables considered together, essentially quantifying how much information is needed to describe the combined outcomes of those variables simultaneously. Furthermore, troubleshooting data is received, which includes reasons for causing abnormal indicators, listing of abnormal indicators, and solutions for addressing abnormal indicators. Troubleshooting data, as used herein, refers to information gathered during the process of identifying and resolving a root cause of an abnormal indicator, including details about the potential causes of an abnormal indicator, steps taken to diagnose, and the eventual solution implemented. A graph (referred to herein as the “knowledge graph”) may then be generated from the troubleshooting data using a knowledge graph algorithm to model the data. A knowledge graph, as used herein, is a representation of nodes representing an abnormal indicator, the reasons for causing the abnormal indicator, the solutions for addressing the abnormal indicator, and the relationships between the nodes. Furthermore, a root cause of the abnormal indicator is identified using the data structure of the log information and the knowledge graph. In one embodiment, the root cause is determined by identifying the smallest distance between the abnormal indicator in question and the reason for causing the abnormal indicator in question from the knowledge graph. A recovery command associated with the identified root cause of the abnormal indicator is then retrieved from a repository and implemented. In this manner, the root cause for abnormal indicators in the operational data collector can be accurately and quickly identified as well as addressed. These and other features will be discussed in further detail below.

In some embodiments of the present disclosure, the present disclosure comprises a computer-implemented method, system, and computer program product for identifying root causes of abnormal indicators in operational data collectors (e.g., ZCDP). In one embodiment of the present disclosure, an error message or a prediction of an error message pertaining to an abnormal indicator is received. Log information from a component of the operational data collector associated with the error message is then received and transformed into a data structure using the joint entropy of information theory. Furthermore, troubleshooting data, which includes reasons for causing abnormal indicators, listing of abnormal indicators, and solutions for addressing abnormal indicators, is also received. A graph (referred to herein as the “knowledge graph”) is then generated from the troubleshooting data using a knowledge graph algorithm to model the data. As discussed above, a knowledge graph, as used herein, is a representation of nodes representing an abnormal indicator, the reasons for causing the abnormal indicator, the solutions for addressing the abnormal indicator, and the relationships between the nodes. Furthermore, a root cause of the abnormal indicator is identified using the data structure of the log information and the knowledge graph. In one embodiment, the root cause is determined by identifying the smallest distance between the abnormal indicator in question and the reason for causing the abnormal indicator in question from the knowledge graph. A recovery command associated with the identified root cause of the abnormal indicator is then retrieved from a repository and implemented. In this manner, the root cause for abnormal indicators in the operational data collector can be accurately and quickly identified as well as addressed.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

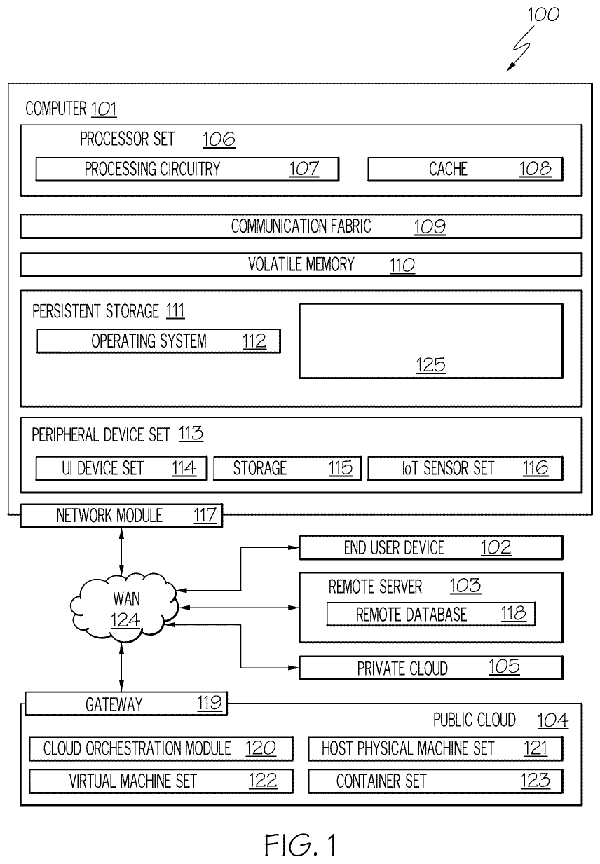

Referring now to the Figures in detail, FIG. 1 illustrates an embodiment of the present disclosure of a computing environment 100 for practicing the principles of the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code (stored in block 125) involved in performing the inventive methods, such as accurately and quickly identifying the root cause of abnormal indicators in the operational data collector (e.g., IBM Z® Common Data Provider (ZCDP)). In addition to block 125, computing environment 100 includes, for example, computer 101, network 124, such as a wide area network (WAN), end user device (EUD) 102, remote server 103, public cloud 104, and private cloud 105. In this embodiment, computer 101 includes processor set 106 (including processing circuitry 107 and cache 108), communication fabric 109, volatile memory 110, persistent storage 111 (including operating system 112 and block 125, as identified above), peripheral device set 113 (including user interface (UI) device set 114, storage 115, and Internet of Things (IoT) sensor set 116), and network module 117. Remote server 103 includes remote database 118. Public cloud 104 includes gateway 119, cloud orchestration module 120, host physical machine set 121, virtual machine set 122, and container set 123.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 118. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 106 includes one, or more, computer processors of any type now known or to be developed in the future. Processing circuitry 107 may be distributed over multiple packages, for example, multiple, coordinated integrated circuit chips. Processing circuitry 107 may implement multiple processor threads and/or multiple processor cores. Cache 108 is memory that is located in the processor chip package(s) and is typically used for data or code that should be available for rapid access by the threads or cores running on processor set 106. Cache memories are typically organized into multiple levels depending upon relative proximity to the processing circuitry. Alternatively, some, or all, of the cache for the processor set may be located “off chip.” In some computing environments, processor set 106 may be designed for working with qubits and performing quantum computing.

Computer readable program instructions are typically loaded onto computer 101 to cause a series of operational steps to be performed by processor set 106 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 108 and the other storage media discussed below. The program instructions, and associated data, are accessed by processor set 106 to control and direct performance of the inventive methods. In computing environment 100, at least some of the instructions for performing the inventive methods may be stored in block 125 in persistent storage 111.

Communication fabric 109 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 110 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 110 is located in a single package and is internal to computer 101, but, alternatively or additionally, the volatile memory may be distributed over multiple packages and/or located externally with respect to computer 101.

Persistent Storage 111 is any form of non-volatile storage for computers that is now known or to be developed in the future. The non-volatility of this storage means that the stored data is maintained regardless of whether power is being supplied to computer 101 and/or directly to persistent storage 111. Persistent storage 111 may be a read only memory (ROM), but typically at least a portion of the persistent storage allows writing of data, deletion of data and re-writing of data. Some familiar forms of persistent storage include magnetic disks and solid state storage devices. Operating system 112 may take several forms, such as various known proprietary operating systems or open source Portable Operating System Interface type operating systems that employ a kernel. The code included in block 125 typically includes at least some of the computer code involved in performing the inventive methods.

Peripheral device set 113 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 114 may include components such as a display screen, speaker, microphone, wearable devices (such as goggles and smart watches), keyboard, mouse, printer, touchpad, game controllers, and haptic devices. Storage 115 is external storage, such as an external hard drive, or insertable storage, such as an SD card. Storage 115 may be persistent and/or volatile. In some embodiments, storage 115 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 116 is made up of sensors that can be used in Internet of Things applications. For example, one sensor may be a thermometer and another sensor may be a motion detector.

Network module 117 is the collection of computer software, hardware, and firmware that allows computer 101 to communicate with other computers through WAN 124. Network module 117 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 117 are performed on the same physical hardware device. In other embodiments (for example, embodiments that utilize software-defined networking (SDN)), the control functions and the forwarding functions of network module 117 are performed on physically separate devices, such that the control functions manage several different network hardware devices. Computer readable program instructions for performing the inventive methods can typically be downloaded to computer 101 from an external computer or external storage device through a network adapter card or network interface included in network module 117.

WAN 124 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 102 is any computer system that is used and controlled by an end user (for example, a customer of an enterprise that operates computer 101), and may take any of the forms discussed above in connection with computer 101. EUD 102 typically receives helpful and useful data from the operations of computer 101. For example, in a hypothetical case where computer 101 is designed to provide a recommendation to an end user, this recommendation would typically be communicated from network module 117 of computer 101 through WAN 124 to EUD 102. In this way, EUD 102 can display, or otherwise present, the recommendation to an end user. In some embodiments, EUD 102 may be a client device, such as thin client, heavy client, mainframe computer, desktop computer and so on.

Remote server 103 is any computer system that serves at least some data and/or functionality to computer 101. Remote server 103 may be controlled and used by the same entity that operates computer 101. Remote server 103 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 118 of remote server 103.

Public cloud 104 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 104 is performed by the computer hardware and/or software of cloud orchestration module 120. The computing resources provided by public cloud 104 are typically implemented by virtual computing environments that run on various computers making up the computers of host physical machine set 121, which is the universe of physical computers in and/or available to public cloud 104. The virtual computing environments (VCEs) typically take the form of virtual machines from virtual machine set 122 and/or containers from container set 123. It is understood that these VCEs may be stored as images and may be transferred among and between the various physical machine hosts, either as images or after instantiation of the VCE. Cloud orchestration module 120 manages the transfer and storage of images, deploys new instantiations of VCEs and manages active instantiations of VCE deployments. Gateway 119 is the collection of computer software, hardware, and firmware that allows public cloud 104 to communicate through WAN 124.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 105 is similar to public cloud 104, except that the computing resources are only available for use by a single enterprise. While private cloud 105 is depicted as being in communication with WAN 124 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 104 and private cloud 105 are both part of a larger hybrid cloud.

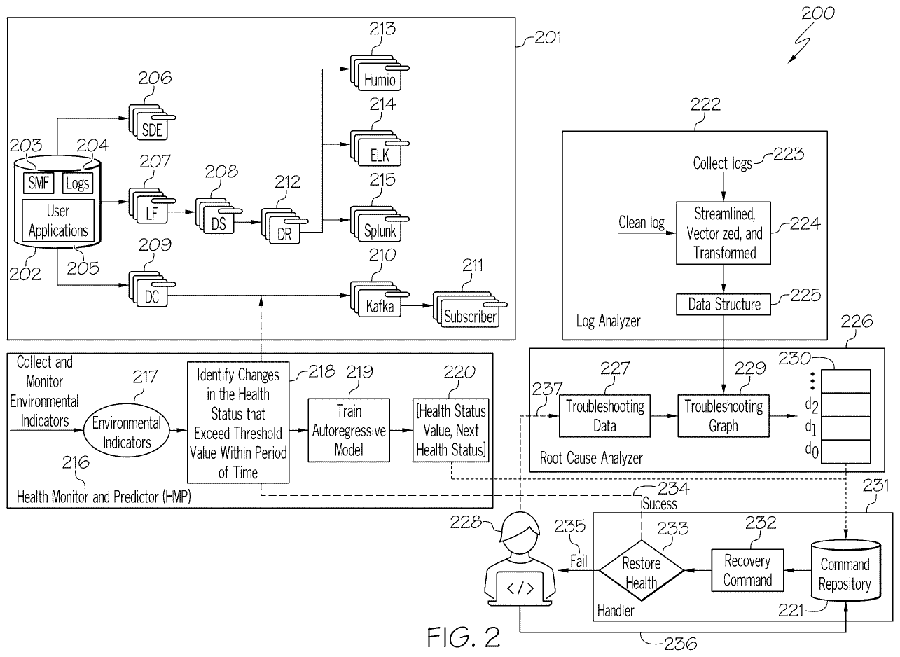

Block 125 further includes the software components discussed herein in connection with FIGS. 2-5 to accurately and quickly identify the root cause of abnormal indicators in the operational data collector (e.g., IBM Z® Common Data Provider (ZCDP)). In one embodiment, such components may be implemented in hardware. The functions discussed herein performed by such components are not generic computer functions. As a result, computer 101 is a particular machine that is the result of implementing specific, non-generic computer functions.

In one embodiment, the functionality of such software components of computer 101, including accurately and quickly identifying the root cause of abnormal indicators in the operational data collector, may be embodied in an application specific integrated circuit.

An embodiment of computer 101 (FIG. 1) implementing the system for accurately and quickly identifying the root cause of abnormal indicators in the operational data collector (e.g., IBM Z® Common Data Provider (ZCDP)) is discussed below in connection with FIG. 2.

FIG. 2 illustrates a system architecture 200 for accurately and quickly identifying the root cause of abnormal indicators in the operational data collector (e.g., IBM Z® Common Data Provider (ZCDP)) in accordance with an embodiment of the present disclosure.

Referring to FIG. 2, in conjunction with FIG. 1, system architecture 200 includes an operational data collector 201 (e.g., IBM Z® Common Data Provider (ZCDP)) configured to gather and stream operational data from a system (e.g., z/OS® system) to various analytics platforms. In one embodiment, operational data collector 201 includes a repository 202 storing operational data to be collected and streamed. Examples of such data include System Management Facilities (SMF) data 203, log data 204, and user applications 205. SMF data 203, as used herein, refers to the information collected and recorded by the “System Management Facility” (SMF), a feature within IBM's z/OS® mainframe operating system, which acts as a logging mechanism to capture detailed activity happening across the system, including system-level events, application usage, security details, and resource utilization. Log data 204, as used herein, refers to a record of events. Examples of log data 204 include IBM® Information Management System (IMS) logs, SYLOG (z/OS® system logs), and other z/OS® logs, such as job logs (file that records a job's execution details, including the commands used in the job, the start and end times of the job, any error messages or failure notices, system messages from the batch container, output from the job executables, etc.) and application logs (records created by software applications during their runtime, capturing details about events, user interactions, system errors, and other activities within the application). User applications 205, as used herein, refer to computer programs that perform tasks, such as a real-time monitoring dashboard on a platform, such as Splunk®.

Furthermore, operational data collector 201 includes various components performing various functions, such as the system data engine (SDE) 206, which is responsible for collecting operational data from various z/OS® systems, including system logs, performance metrics, and other relevant data sources.

Another component of operational data collector 201 is the log forwarder (LF) 207 that collects z/OS log data. In one embodiment, log forwarder 207 collects log data from job logs, z/OS® log files, SYLOG (z/OS® system logs), OPERLOG (a log of system messages that spans an entire sysplex in IBM's MVS (multiple virtual storage) system), and middleware logs.

A further component of operational data collector 201 is the data streamer (DS) 208, which streams data from the data gatherers to configured subscribers in the appropriate format. For instance, data streamer 208 streams data from SDE 206 and LF 207.

Furthermore, another component of operational data collector 201 is the data collector (DC) 209, which is a lightweight component that streams or batch-loads operational data from z/OS® to an Apache® Kafka® 210 (or Apache® Kafka® cluster) or broker. Apache® Kafka® 210 is an open-source platform that manages and analyzes streaming data in real time. Data is streamed through the Kafka® platform 210 to a subscriber 211, which refers to a consumer application that actively listens to and receives messages published to a specific topic via Kafka® platform 210.

A further component of operational data collector 201 is the data receiver (DR) 212, which is configured to stream data from data streamer (DS) 208 to a number of destinations, such as Humio® 213 (log management platform that helps users analyze, aggregate, and report on data from a variety of sources), ELK® 214 (Elasticsearch, Logstash, and Kibana), which is a set of open source products that can be used with ZCDP to collect operational data, forward data to other productions, build visualizations, and detect incidents, and Splunk® 215 (data platform that helps organizations analyze, search, and visualize large amounts of data in real time).

Furthermore, in one embodiment, system architecture 200 includes a health monitor and predictor module 216 configured to monitor the health status of the components of operational data collector 201 as well as predict the future health status of such components.

In one embodiment, health monitor and predictor module 216 collects and monitors for changes in environmental indicators 217. Environmental indicators 217, as used herein, refers to data that can be used to identify trends and anomalies in operational data collector 201. Examples of such environmental indicators 217 include, but are not limited to, CPU utilization, memory utilization, network latency, disk space utilization, job queue lengths, specific application performance data, etc.

Furthermore, in one embodiment, health monitor and predictor module 216 identifies changes in the health status of the components of operational data collector 201 that exceed a threshold value, which may be user-designated, within a period of time based on an indicator change (see element 218)

Such identified changes may then be used to train an autoregressive model (see element 219) to predict the future health status 220 of the components of operational data collector 201, including errors caused by abnormal indicators. An autoregressive model, as used herein, refers to a machine learning technique that uses past data to predict future values in a time series. Autoregressive models are based on the assumption that the current value of a time series is a function of its past values.

In one embodiment, the autoregressive model is trained to predict the future health status 220 of the components of operational data collector 201, including errors caused by abnormal indicators, by splitting data into training and testing sets and then fitting the autoregressive model by calculating the coefficients that best relate the current value to its lagged (past) values using methods, such as least squares regression, and using those coefficients to predict future values based on the most recent data points in time series. For example, the predicted future health status 220 of the component of operational data collector 201 includes the current health status value and the predicted (or next) health status value.

An example of an algorithm for training the autoregressive model to predict the future health status of the components of operational data collector 201 using environmental indicators 217 corresponding to CPU utilization (percentage of time a central processing unit (CPU) is actively working on tasks), memory utilization (amount of memory the operational data collector is using at any given time, expressed as a percentage of the total available memory), network latency (time it takes for a data packet to travel from its source to its destination on a network), and disk space utilization (amount of storage capacity currently being used by files and data) is provided further below, where y corresponds to the current health status of the component of operational data collector 201 and yₜ₊₁ corresponds to the predicted health status of the component of operational data collector 201. If the changes in the health status of a component of operational data collector 201 exceeds a threshold value, which may be user-designated, a warning is issued thereby training the autoregressive model to predict the future health status of the components of operational data collector 201. The pseudo code for implementing such an algorithm is provided below.

Tₘ : Begin time Tₙ : Sampling end time
ΔT= Tₙ − Tₘ
ΔC=C_{T}_{ₙ}₋C_{T}_{ₘ} , C represents CPU Utilization
ΔM=M_{T}_{ₙ}₋M_{T}_{ₘ}, M represents Memory Utilization
ΔN=N_{T}_{ₙ}₋N_{T}_{ₘ}, N represents Network Latency
ΔS=S_{T}_{ₙ}₋S_{T}_{ₘ}, S represents Disk Space Utilization
If (ΔC> threshold∩ ΔM > threshold ∩ ΔM > threshold ∩ ΔS> threshold)
{ return (type,warning) }
x₀ : CPU usage at time t
x₁: Memory usage at time t
x₂: Network Latency at time t
x₃: Space usage at time t
y = ax₀ + bx₁ + cx₂ + dx₃ + δ
yₜ₊₁ = β + β₀yₜ + εₜ₊₁

Such future predictions may be stored in a repository 221, referred to herein as the “command repository,” which is configured to store recovery commands to resolve the root cause of abnormal indicators.

System architecture 200 further includes a log analyzer 222 configured to receive an error message generated from an abnormal indicator detected during the processing of an operational data collector involving a component of operational data collector 201 or configured to receive a prediction of an error message to be generated from an abnormal indicator predicted to occur based on the predicted health status of a component of operational data collector 201 by health monitor and predictor module 216.

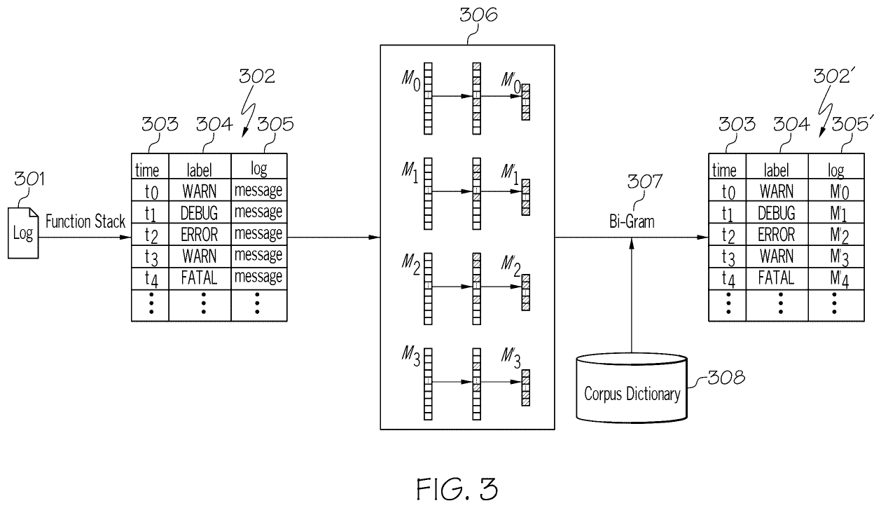

Log analyzer 222 is further configured to receive log information 223 from the component of operational data collector 201 associated with the error message. In one embodiment, such log information is streamlined, vectorized, and transformed 224 into a data structure 225, such as by using the joint entropy of information theory as discussed below in connection with FIG. 3.

Referring to FIG. 3, FIG. 3 illustrates using the joint entropy of information theory to streamline, vectorize, and transform log information into a data structure in accordance with an embodiment of the present disclosure.

As shown in FIG. 3, the function stack of a log 301, which refers to the sequence of function calls that led to a specific log entry, which essentially shows the chain of function executions that resulted in the logged information as shown in data structure 302. As illustrated in FIG. 3, data structure 302 includes the chain of function executions, including information, such as time 303 of the function execution. Furthermore, data structure includes a label 304 of the function execution, which indicates the severity level of the event being logged (e.g., warning, debug, error, fatal, etc.). The “warning” label signifies a potential problem that might need attention, the “debug” label provides detailed information for development purposes, the “error” label indicates a clear malfunction, and a “fatal” label signifies a critical system failure that prevents further operation. Furthermore, data structure 302 includes the log 305 (e.g., message).

The data of each label 304 may be repeated or redundant. In one embodiment, log analyzer 222 streamlines the log information by removing such redundant data thereby simplifying the log information. In one embodiment, such redundant data is removed from the log information using the joint entropy information theory to select the most informative data in the received log information. For example, n records from the received log information are selected from dataset Mᵢ of one label to form a new dataset

$${M}_{i}^{′} , {M}_{i}^{′} ⊂ {M}_{i} , m = size ( {M}_{i}^{′} ) , where {M}_{i}^{′}$$

is a vector representing log 301 at time t and contains as much information as possible. Log analyzer 222 then uses the joint entropy information theory to measure the amount of information contained in

$${M}_{i}^{′}$$

as shown in the following formula.

$$H ( {M}_{i}^{′} ) = H ( {H}_{0} , … , {X}_{n} ) = - {\sum }_{{x}_{0} ∈ {X}_{0}} … {\sum }_{{x}_{n ∈ {X}_{n}}} P ( {x}_{0} , … , {x}_{n} ) log P ( {x}_{0} , … , {x}_{n} ) ;$$

$${X}_{0} , … , {X}_{n} ∈ {M}_{i}^{′}$$

As further shown in FIG. 3, log analyzer 222, using the joint entropy information theory, selects n records from various datasets, M₀, M₁, M₂, and M₃ of one label to form a new dataset M₀′, M₁′, M₂′, and M₃′, respectively, as shown in element 306. The log 305 in data structure 302 is updated to reflect the most informative data using bi-grams 307 (two words coming together in the corpus) from corpus dictionary 308 (entire collection of words) to form an updated data structure 302′ (equivalent to data structure 225) with an updated log 305′ reflecting the most informative data. Such bi-grams 307 are used to measure the information contained in the new datasets.

An illustrative example of log analyzer 222 streamlining, vectorizing, and transforming the log information into a data structure using the joint entropy of information theory is provided below.

Suppose that n samples of the received log information are selected from an original sub-dataset Mᵢ to form n new sub-dataset

$${M}_{i}^{′} , where {M}_{i}^{′} ⊂ {M}_{i} and n = size ( {M}_{i}^{′} ) and {X}_{1} , … , {X}_{n} ∈ {M}_{i}^{′} .$$

The task is for

$${M}_{i}^{′}$$

to contain as much Information as possible, represented in the following formula.

$$H ( {M}_{i}^{′} ) = H ( {X}_{1} , … , {X}_{n} ) = - {\sum }_{{x}_{1 ∈ {X}_{1}}} … {\sum }_{{x}_{n} ϵ {x}_{n}} P ( {x}_{1} , … , {x}_{n} ) log P ( {x}_{1} , … , {x}_{n} )$$

It is noted that x₁, . . . , xₙ are the different values in samples X₁, . . . , Xₙ. Furthermore, P(x₁, . . . , xₙ) is the probability that these values appear together at the same time. Additionally, P(x₁, . . . , xₙ)log P(x₁, . . . , xₙ)=0 if P(x₁, . . . , xₙ)=0.

Returning to FIG. 2, system architecture 200 additionally includes root cause analyzer 226 configured to receive troubleshooting data 227, which includes reasons for causing abnormal indicators, listing of abnormal indicators, and solutions for addressing abnormal indicators. Troubleshooting data, as used herein, refers to information gathered during the process of identifying and resolving a root cause of an abnormal indicator, and the eventual solution implemented. In one embodiment, such troubleshooting data 227 is provided by a user 228, such as a user of computer 101.

In one embodiment, root cause analyzer 226 converts troubleshooting data 227 into structured data. In one embodiment, root cause analyzer 226 converts the troubleshooting data into structured data by identifying key data points within the unstructured text and then defining a standardized schema to categorize and organized such information, such as by using natural language processing to extract the relevant details and mapping them to the structured format.

For example, in one embodiment, root cause analyzer 226 first cleans the received troubleshooting data 227, such as by removing unnecessary spaces, punctuations, and special characters. Furthermore, root cause analyzer 226 identifies the relevant information in the received troubleshooting data 227, such as by extracting the key elements, such as error codes, steps taken, resolution, device details, etc.

Next, in one embodiment, root cause analyzer 226 defines a schema, which describes how data is organized. In one embodiment, root cause analyzer 226 defines a schema by defining the data fields. For example, root cause analyzer 226 creates a structured schema with relevant attributes, such as “problem description,” “error code,” “resolution steps,” “timestamp,” etc. Furthermore, root cause analyzer 226 defines a schema by establishing data types, such as assigning data types to each field (e.g., text, number, date, etc.).

Furthermore, in one embodiment, root cause analyzer 226 next performs data extraction with natural language processing, such as by performing tokenization, part-of-speech tagging, named entity recognition, and text classification. Tokenization involves breaking down the text into individual words or phrases. Part-of-speech tagging involves identifying the grammatical role of each word (e.g., noun, verb, adjective, etc.). Named entity recognition involves extracting specific entities, such as device names, error codes, user names, etc. Text classification involves categorizing issues based on problem type or severity.

Additionally, in one embodiment, root cause analyzer 226 next performs data mapping, such as extracting relevant information. In one embodiment, root cause analyzer 226 uses natural language processing techniques to identify and extract the necessary data from the unstructured data and map it to the corresponding fields in the schema. In one embodiment, root cause analyzer 226 develops rules or uses machine learning models to revolve any ambiguities in text interpretation.

Root cause analyzer 226 may utilize various software tools for converting troubleshooting data into structure data as discussed above, including, but not limited to, Talend®, Informatica® PowerCenter®, Hevo® Data, Datameer®, Apache® Spark, Microsoft® Azure®, etc.

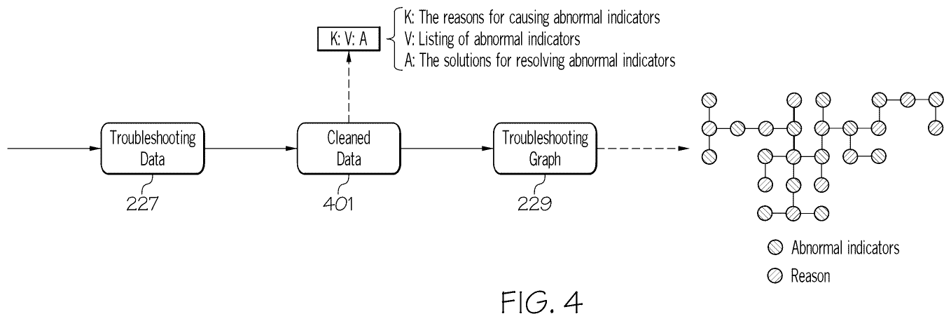

Furthermore, in one embodiment, root cause analyzer 226 generates a graph 229 (referred to herein as the “troubleshooting graph”) from the troubleshooting data, such as in structured form, using a knowledge graph algorithm to model data as shown in FIG. 4. A knowledge graph, as used herein, is a representation of nodes representing an abnormal indicator, and the relationships between the nodes.

Referring to FIG. 4, FIG. 4 illustrates modeling based on troubleshooting data in accordance with an embodiment of the present disclosure.

As shown in FIG. 4, root cause analyzer 226 receives troubleshooting data 227, which is then converted into structured data (cleaned data 401) as discussed above. In one embodiment, such cleaned data 401 includes K:V:A, where K are the reasons for causing abnormal indicators, V corresponds to the listing of abnormal indicators, and A are the solutions for resolving abnormal indicators.

Furthermore, as shown in FIG. 4, a knowledge graph algorithm is utilized to model the data in troubleshooting graph 229. A knowledge graph algorithm, as used herein, refers to a computational process designed to analyze and manipulate data within a knowledge graph, which is a structured representation of information where entities (e.g., people, places, or concepts) are connected by relationships.

In one embodiment, root cause analyzer 226 generates graph 229 from the troubleshooting data, such as in structured form, using a knowledge graph algorithm to model data by identifying the relevant entities and relationships within the structured data, which are represented as nodes and edges in a graph structure.

In one embodiment, the knowledge graph algorithm generates troubleshooting graph 229 to model data by performing entity extraction and identification, relationship extraction, entity disambiguation, modeling, data loading and mapping, and visualization.

In one embodiment, the knowledge graph algorithm performs entity extraction and identification by utilizing natural language processing (NLP) techniques to identify key entities (e.g., error codes, solutions for resolving abnormal indicators, etc.) within the structured data.

In one embodiment, the knowledge graph algorithm performs relationship extraction by analyzing the text to identify relationships between extracted entities, defining the type of connection (e.g., “is located in,” “works for,” “related to”).

In one embodiment, the knowledge graph algorithm performs entity disambiguation by using additional information to resolve potential duplicates and ensure consistent representation.

In one embodiment, the knowledge graphs algorithm models the graph structure by representing the entities as nodes and the relationships as edges as well as defining properties for each node and edge to store additional information.

In one embodiment, the knowledge graph algorithm performs data loading and mapping by loading the extracted entities and relationships into the graph database and mapping them to the appropriate node and edge types.

In one embodiment, the knowledge graph algorithm performs visualization by utilizing graph visualization tools to visually represent the knowledge graph.

Examples of software tools utilized by root cause analyzer 226 to generate troubleshooting graph 229 using the knowledge graph algorithm to model data as discussed above, include, but are not limited to, Neo4j®, Stardog®, Amazon Neptune®, Microsoft® Azure Cosmos DB®, AllegroGraph®, etc.

In one embodiment, the knowledge graph algorithm of the present disclosure performs knowledge extraction, entity linking, and relationship modeling to generate troubleshooting graph 229.

With respect to knowledge extraction, assuming that the proportion of samples of the Kth category in the current sample set D is pₖ, then the information entropy of D is:

$$Ent ( D ) = - {\sum }_{k = 1}^{\vert y \vert} {p}_{k} {log}_{2} {p}_{k} .$$

The smaller the value of Ent (D), the higher the purity of D.

$$Gain ( D , a ) = Ent ( D ) - {\sum }_{v = 1}^{V} \frac{\vert {D}^{v} \vert}{\vert D \vert} Ent ( {D}^{v} ) .$$

The greater the information gain, the greater the “purity improvement” obtained by using attribute a to divide.

With respect to entity linking, the knowledge graph algorithm of the present disclosure utilizes the contextual information of entities in text for entity linking. In one embodiment, the knowledge graph algorithm determines the semantic consistency of an entity by analyzing the words, sentence structure, semantic roles, and other features around the entity.

With respect to relationship modeling, the knowledge graph algorithm defines how different entities within the system are connected or related to each other. In one embodiment, such entities are the data points (e.g., reasons for causing abnormal indicators, solutions for resolving abnormal indicators). Furthermore, in one embodiment, the knowledge graph algorithm then forms connections between the entities, describing how they interact with each other. In one embodiment, the knowledge graph algorithm describes the number of relationships that can exist between entities.

Examples of software tools utilized by root cause analyzer 226 to generate troubleshooting graph 229 using the knowledge graph algorithm to model data as discussed above, include, but are not limited to, Neo4j®, Amazon Neptune®, Microsoft® Azure Cosmos DB®, SpaCy®, NLTK, Relik®, etc.

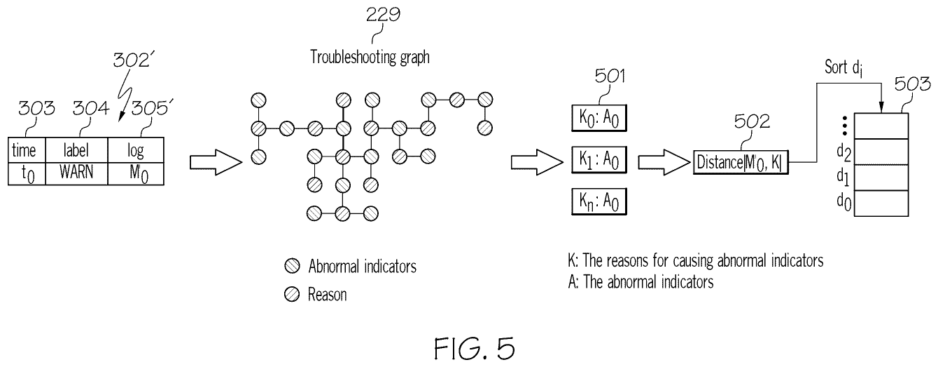

Returning to FIG. 2, root cause analyzer 226 is further configured to identify the root cause of the abnormal indicator using data structure 225 of the log information and troubleshooting graph 229 as shown by element 230, which corresponds to a list of root causes for the abnormal indicator, ranked from being the most likely cause to the least likely cause for the abnormal indicator as discussed below in connection with FIG. 5.

FIG. 5 illustrates identifying the root cause of the abnormal indicator using data structure 225 of the log information and troubleshooting graph 229 in accordance with an embodiment of the present disclosure.

Referring to FIG. 5, in conjunction with FIGS. 2-4, data structure 225 (equivalent to data structure 302′) is utilized to identify the root cause of the abnormal indicator based on utilizing the information stored in such a data structure, such as the label 304 and log 305′ (reflecting the most informative data). Furthermore, troubleshooting graph 229 is utilized to quickly query the causes of the abnormal indicators.

When there is only one root cause for the abnormal indicator, the root cause is returned directly. However, an abnormal indicator may be caused by several reasons. As a result, in one embodiment, root cause analyzer 226 calculates the distance between log 305′ and K, where K is a reason for causing an abnormal indicator (A) found in troubleshooting graph 229. Based on analyzing troubleshooting graph 229 for an abnormal indicator identified in data structure 302′, root cause analyzer 226 calculates the distances (see element 501) between various reasons for causing such an abnormal indicator (e.g., K₀:A₀, K₁:A₀, . . . Kₙ:A₀). For example, root cause analyzer 226 calculates the distance between the root cause K₀ for causing abnormal indicator A₀ as well as calculates the distance between the root cause K₁ for causing abnormal indicator A₀ and so forth. Such distances are based on the distances between such causes and the abnormal indicator as graphed in troubleshooting graph 229.

In one embodiment, such calculations correspond to the distance |M₀′, K| 502, which is then sorted based on the distance from shortest to largest as shown in element 503. The smallest distance corresponds to the root cause for the abnormal indicator. A formula for calculating the distance between log 305′ and K is provided below.

distance

$$\vert {M}_{i}^{′} , {K}_{i} \vert = \frac{{M}_{i}^{′} \cdot {K}_{i}}{‖ {M}_{i}^{′} ‖ \times ‖ {K}_{i} ‖} .$$

In one embodiment, root cause analyzer 226 identifies the root cause of the abnormal indicator using data structure 225 of the log information and troubleshooting graph 229 as discussed above using various software tools, including, but not limited to, Splunk®, Elastic Slack (ELK®), Sumo Logic®, Datadog®, Prometheus®, Grafana®, etc.

In one embodiment, root cause analyzer 226 stores the list of root causes for the abnormal indicator into repository 221.

Returning to FIG. 2, system architecture 200 further includes handler 231 configured to retrieve the corresponding recovery command 232 from command repository 221, which is then implemented. The “corresponding recovery command,” as used herein, refers to the recovery command associated with the identified root cause of the abnormal indicator that was identified by root cause analyzer 226. A “recovery command,” as used herein, refers to a system command to resolve the cause of the abnormal indicator in operational data collector 201.

In one embodiment, command repository 221 stores a listing of recovery commands 232 associated with the root causes of abnormal indicators. In one embodiment, command repository 221 is populated by an expert. Upon root cause analyzer 226 identifying a root cause of the abnormal indicator, handler 231 performs a search in command repository 221 for recovery command 232 associated with the identified root cause of the abnormal indicator.

Furthermore, in one embodiment, after implementing the retrieved recovery command 232, handler 231 determines if recovery command 232 successfully resolved the abnormal indicator. That is, handler 231 determines if recovery command 232 restores the health of the component of operational data collector 201 associated with the abnormal indicator (see element 233).

In one embodiment, handler 231 determines if recovery command 232 successfully resolved the abnormal indicator by monitoring system behavior of operational data collector 201 after running the recovery command to determine if the issue has been resolved. In one embodiment, handler 231 reviews logs or specific output from recovery command 232 to determine if the issue has bene resolved.

If recovery command 232 resolved the abnormal indicator, then handler 231 restores the health status of the component in operational data collector 201 associated with the abnormal indicator (see element 234).

If, however, recovery command 232 does not resolve the abnormal indicator, then handler 231 issues a message to user 228 (e.g., user of computer 101) regarding not resolving the abnormal indicator (see element 235).

Furthermore, if the recovery command does not resolve the abnormal indicator, then user 228 may proceed to resolve the abnormal indicator manually. The corresponding recovery command used to resolve the abnormal indicator is then added to command repository 221 to be used in the future to resolve the corresponding abnormal indicator (see element 236). Furthermore, in one embodiment, such a recovery command is added to troubleshooting data 227 (see element 237) to retrain and generate troubleshooting graph 229 as discussed above.

In this manner, the root cause for abnormal indicators in the operational data collector can be accurately and quickly identified as well as addressed.

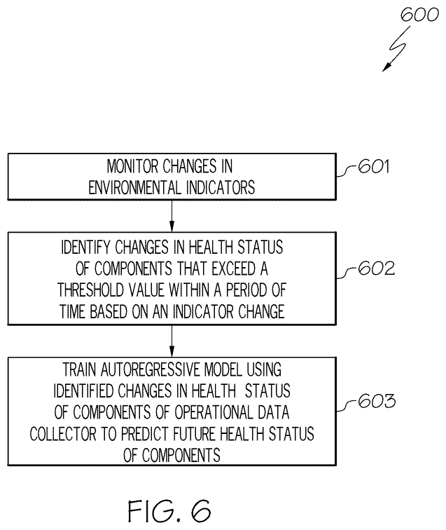

In connection with identifying such a root cause, the future health status of the components in operational data collector 201 may need to be predicted as discussed below in connection with FIG. 6.

FIG. 6 is a flowchart of a method 600 for predicting the future health status of the components in the operational data collector (e.g., operational data collector 201) in accordance with an embodiment of the present disclosure.

Referring to FIG. 6, in conjunction with FIGS. 1-5, in step 601, health monitor and predictor module 216 monitors changes in environmental indicators 217.

As discussed above, environmental indicators 217, as used herein, refers to data that can be used to identify trends and anomalies in operational data collector 201. Examples of such environmental indicators 217 include, but are not limited to, CPU utilization, memory utilization, network latency, disk space utilization, job queue lengths, specific application performance data, etc.

In step 602, health monitor and predictor module 216 identifies changes in the health status of the components of operational data collector 201 that exceed a threshold value, which may be user-designated, within a period of time based on an indicator change (see element 218)

In step 603, health monitor and predictor module 216 trains an autoregressive model (see element 219) using such identified changes to predict the future health status 220 of the components of operational data collector 201, including errors caused by abnormal indicators.

As stated above, an autoregressive model, as used herein, refers to a machine learning technique that uses past data to predict future values in a time series. Autoregressive models are based on the assumption that the current value of a time series is a function of its past values.

In one embodiment, the autoregressive model is trained to predict the future health status 220 of the components of operational data collector 201, including errors caused by abnormal indicators, by splitting data into training and testing sets and then fitting the autoregressive model by calculating the coefficients that best relate the current value to its lagged (past) values using methods, such as least squares regression, and using those coefficients to predict future values based on the most recent data points in time series. For example, the predicted future health status 220 of the component of operational data collector 201 includes the current health status value and the predicted (or next) health status value.

An example of an algorithm for training the autoregressive model to predict the future health status of the components of operational data collector 201 using environmental indicators 217 corresponding to CPU utilization (percentage of time a central processing unit (CPU) is actively working on tasks), memory utilization (amount of memory the operational data collector is using at any given time, expressed as a percentage of the total available memory), network latency (time it takes for a data packet to travel from its source to its destination on a network), and disk space utilization (amount of storage capacity currently being used by files and data) is provided further below, where y corresponds to the current health status of the component of operational data collector 201 and yₜ₊₁ corresponds to the predicted health status of the component of operational data collector 201. If the changes in the health status of a component of operational data collector 201 exceeds a threshold value, which may be user-designated, a warning is issued thereby training the autoregressive model to predict the future health status of the components of operational data collector 201. The pseudo code for implementing such an algorithm is provided below.

Tₘ : Begin time Tₙ : Sampling end time
ΔT= Tₙ − Tₘ
ΔC=C_{T}_{ₙ}₋C_{T}_{ₘ} , C represents CPU Utilization
ΔM=M_{T}_{ₙ}₋M_{T}_{ₘ}, M represents Memory Utilization
ΔN=N_{T}_{ₙ}₋N_{T}_{ₘ}, N represents Network Latency
ΔS=S_{T}_{ₙ}₋S_{T}_{ₘ}, S represents Disk Space Utilization
If (ΔC> threshold∩ ΔM > threshold ∩ ΔM > threshold ∩ ΔS> threshold)
{ return (type,warning) }
x₀ : CPU usage at time t
x₁: Memory usage at time t
x₂: Network Latency at time t
x₃: Space usage at time t
y = ax₀ + bx₁ + cx₂ + dx₃ + δ
yₜ₊₁ = β + β₀yₜ + εₜ₊₁

Such future predictions may be stored in repository 221 (“command repository”), which is configured to store recovery commands to resolve the root cause of abnormal indicators.

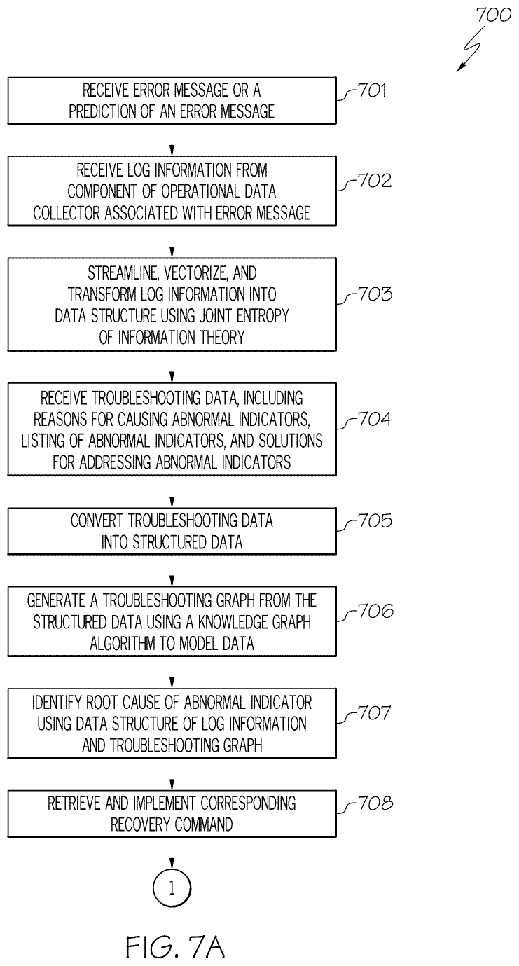

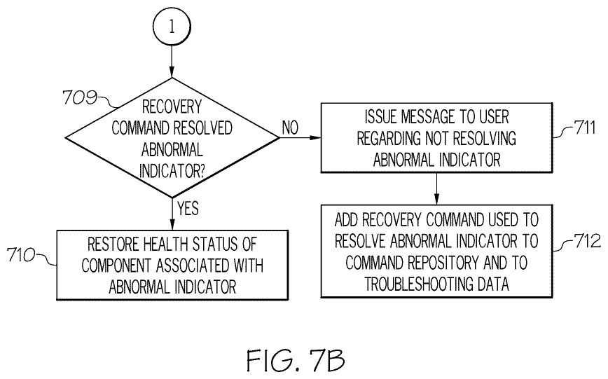

Such root causes of abnormal indicators are accurately and quickly identified as discussed below in connection with FIGS. 7A-7B.

FIGS. 7A-7B are a flowchart of a method 700 for accurately and quickly identifying the root cause of abnormal indicators in the operational data collector (e.g., operational data collector 201) in accordance with an embodiment of the present disclosure.

Referring to FIG. 7A, in conjunction with FIGS. 1-5, in step 701, log analyzer 222 receives an error message generated from an abnormal indicator detected during the processing of operational data collector 201 involving a component of operational data collector 201 or receives a prediction of an error message to be generated from an abnormal indicator predicted to occur based on the predicted health status of a component of operational data collector 201 by health monitor and predictor module 216.

In step 702, log analyzer 222 receives log information 223 from the component of operational data collector 201 associated with the error message.

In step 703, log analyzer 222 streamlines, vectorizes, and transforms the received log information 223 into a data structure 225, such as by using the joint entropy of information theory as discussed below in connection with FIG. 3.

As shown in FIG. 3, the function stack of a log 301, which refers to the sequence of function calls that led to a specific log entry, which essentially shows the chain of function executions that resulted in the logged information as shown in data structure 302. As illustrated in FIG. 3, data structure 302 includes the chain of function executions, including information, such as time 303 of the function execution. Furthermore, data structure includes a label 304 of the function execution, which indicates the severity level of the event being logged (e.g., warning, debug, error, fatal, etc.). The “warning” label signifies a potential problem that might need attention, the “debug” label provides detailed information for development purposes, the “error” label indicates a clear malfunction, and a “fatal” label signifies a critical system failure that prevents further operation. Furthermore, data structure 302 includes the log 305 (e.g., message).

The data of each label 304 may be repeated or redundant. In one embodiment, log analyzer 222 streamlines the log information by removing such redundant data thereby simplifying the log information. In one embodiment, such redundant data is removed from the log information using the joint entropy information theory to select the most informative data in the received log information. For example, n records from the received log information are selected from dataset Mᵢ of one label to form a new dataset

$${M}_{i}^{′} , {M}_{i}^{′} ⊂ {M}_{i} , m = size ( {M}_{i}^{′} ) , where {M}_{i}^{′}$$

is a vector representing log 301 at time t and contains as much information as possible. Log analyzer 222 then uses the joint entropy information theory to measure the amount of information contained in

$${M}_{i}^{′}$$

as shown in the following formula.

$$H ( {M}_{i}^{′} ) = H ( {H}_{0} , … , {X}_{n} ) = - {\sum }_{{x}_{0} ∈ {X}_{0}} … {\sum }_{{x}_{n ∈ {X}_{n}}} P ( {x}_{0} , … , {x}_{n} ) log P ( {x}_{0} , … , {x}_{n} ) ;$$

$${X}_{0} , … , {X}_{n} ∈ {M}_{i}^{′}$$

As further shown in FIG. 3, log analyzer 222, using the joint entropy information theory, selects n records from various datasets, M₀, M₁, M₂, and M₃ of one label to form a new dataset M₀′, M₁′, M₂′, and M₃′, respectively, as shown in element 306. The log 305 in data structure 302 is updated to reflect the most informative data using bi-grams 307 (two words coming together in the corpus) from corpus dictionary 308 (entire collection of words) to form an updated data structure 302′ (equivalent to data structure 225) with an updated log 305′ reflecting the most informative data. Such bi-grams 307 are used to measure the information contained in the new datasets.

An illustrative example of log analyzer 222 streamlining, vectorizing, and transforming the log information into a data structure using the joint entropy of information theory is provided below.

Suppose that n samples of the received log information are selected from an original sub-dataset Mᵢ to form n new sub-dataset

$${M}_{i}^{′} , where {M}_{i}^{′} ⊂ {M}_{i} and n = size ( {M}_{i}^{′} ) and {X}_{1} , … , {X}_{n} ∈ {M}_{i}^{′} .$$

The task is for M′ᵢ to contain as much information as possible, represented in the following formula.

$$H ( {M}_{i}^{′} ) = H ( {X}_{1} , … , {X}_{n} ) = - {\sum }_{{x}_{1 ∈ {X}_{1}}} … {\sum }_{{x}_{n} ϵ {x}_{n}} P ( {x}_{1} , … , {x}_{n} ) log P ( {x}_{1} , … , {x}_{n} )$$

It is noted that x₁, . . . , xₙ are the different values in samples X₁, . . . , Xₙ. Furthermore, P(x₁, . . . , xₙ) is the probability that these values appear together at the same time. Additionally, P(x₁, . . . , xₙ)log P(x₁, . . . , xₙ)=0 if P(x₁, . . . , xₙ)=0.

In step 704, root cause analyzer 226 receives troubleshooting data 227, which includes reasons for causing abnormal indicators, listing of abnormal indicators, and solutions for addressing abnormal indicators.

As discussed above, troubleshooting data, as used herein, refers to information gathered during the process of identifying and resolving a root cause of an abnormal indicator, and the eventual solution implemented. In one embodiment, such troubleshooting data 227 is provided by a user 228, such as a user of computer 101.

In step 705, root cause analyzer 226 converts troubleshooting data 227 into structured data.

As stated above, in one embodiment, root cause analyzer 226 converts the troubleshooting data into structured data by identifying key data points within the unstructured text and then defining a standardized schema to categorize and organized such information, such as by using natural language processing to extract the relevant details and mapping them to the structured format.

For example, in one embodiment, root cause analyzer 226 first cleans the received troubleshooting data 227, such as by removing unnecessary spaces, punctuations, and special characters. Furthermore, root cause analyzer 226 identifies the relevant information in the received troubleshooting data 227, such as by extracting the key elements, such as error codes, steps taken, resolution, device details, etc.

Next, in one embodiment, root cause analyzer 226 defines a schema, which describes how data is organized. In one embodiment, root cause analyzer 226 defines a schema by defining the data fields. For example, root cause analyzer 226 creates a structured schema with relevant attributes, such as “problem description,” “error code,” “resolution steps,” “timestamp,” etc. Furthermore, root cause analyzer 226 defines a schema by establishing data types, such as assigning data types to each field (e.g., text, number, date, etc.).

Furthermore, in one embodiment, root cause analyzer 226 next performs data extraction with natural language processing, such as by performing tokenization, part-of-speech tagging, named entity recognition, and text classification. Tokenization involves breaking down the text into individual words or phrases. Part-of-speech tagging involves identifying the grammatical role of each word (e.g., noun, verb, adjective, etc.). Named entity recognition involves extracting specific entities, such as device names, error codes, user names, etc. Text classification involves categorizing issues based on problem type or severity.

Additionally, in one embodiment, root cause analyzer 226 next performs data mapping, such as extracting relevant information. In one embodiment, root cause analyzer 226 uses natural language processing techniques to identify and extract the necessary data from the unstructured data and map it to the corresponding fields in the schema. In one embodiment, root cause analyzer 226 develops rules or uses machine learning models to revolve any ambiguities in text interpretation.

Root cause analyzer 226 may utilize various software tools for converting troubleshooting data into structure data as discussed above, including, but not limited to, Talend®, Informatica® PowerCenter®, Hevo® Data, Datameer®, Apache® Spark, Microsoft® Azure®, etc.

In step 706, root cause analyzer 226 generates a graph 229 (referred to herein as the “troubleshooting graph”) from the troubleshooting data, such as in structured form, using a knowledge graph algorithm to model data as shown in FIG. 4.

As discussed above, a knowledge graph, as used herein, is a representation of nodes representing an abnormal indicator, and the relationships between the nodes.

As shown in FIG. 4, root cause analyzer 226 receives troubleshooting data 227, which is then converted into structured data (cleaned data 401) as discussed above. In one embodiment, such cleaned data 401 includes K:V:A, where K are the reasons for causing abnormal indicators, V corresponds to the listing of abnormal indicators, and A are the solutions for resolving abnormal indicators.

Furthermore, as shown in FIG. 4, a knowledge graph algorithm is utilized to model the data in troubleshooting graph 229. A knowledge graph algorithm, as used herein, refers to a computational process designed to analyze and manipulate data within a knowledge graph, which is a structured representation of information where entities (e.g., people, places, or concepts) are connected by relationships.

In one embodiment, root cause analyzer 226 generates graph 229 from the troubleshooting data, such as in structured form, using a knowledge graph algorithm to model data by identifying the relevant entities and relationships within the structured data, which are represented as nodes and edges in a graph structure.

In one embodiment, the knowledge graph algorithm generates troubleshooting graph 229 to model data by performing entity extraction and identification, relationship extraction, entity disambiguation, modeling, data loading and mapping, and visualization.

In one embodiment, the knowledge graph algorithm performs entity extraction and identification by utilizing natural language processing (NLP) techniques to identify key entities (e.g., error codes, solutions for resolving abnormal indicators, etc.) within the structured data.

In one embodiment, the knowledge graph algorithm performs relationship extraction by analyzing the text to identify relationships between extracted entities, defining the type of connection (e.g., “is located in,” “works for,” “related to”).

In one embodiment, the knowledge graph algorithm performs entity disambiguation by using additional information to resolve potential duplicates and ensure consistent representation.

In one embodiment, the knowledge graphs algorithm models the graph structure by representing the entities as nodes and the relationships as edges as well as defining properties for each node and edge to store additional information.

In one embodiment, the knowledge graph algorithm performs data loading and mapping by loading the extracted entities and relationships into the graph database and mapping them to the appropriate node and edge types.

In one embodiment, the knowledge graph algorithm performs visualization by utilizing graph visualization tools to visually represent the knowledge graph.

Examples of software tools utilized by root cause analyzer 226 to generate troubleshooting graph 229 using the knowledge graph algorithm to model data as discussed above, include, but are not limited to, Neo4j®, Stardog®, Amazon Neptune®, Microsoft® Azure Cosmos DB®, AllegroGraph®, etc.

In one embodiment, the knowledge graph algorithm of the present disclosure performs knowledge extraction, entity linking, and relationship modeling to generate troubleshooting graph 229.

With respect to knowledge extraction, assuming that the proportion of samples of the Kth category in the current sample set D is pₖ, then the information entropy of D is:

$$Ent ( D ) = - {\sum }_{k = 1}^{\vert y \vert} {p}_{k} {log}_{2} {p}_{k} .$$

The smaller the value of Ent (D), the higher the purity of D.

$$Gain ( D , a ) = Ent ( D ) - {\sum }_{v = 1}^{V} \frac{\vert {D}^{v} \vert}{\vert D \vert} Ent ( {D}^{v} ) .$$

The greater the information gain, the greater the “purity improvement” obtained by using attribute a to divide.

With respect to entity linking, the knowledge graph algorithm of the present disclosure utilizes the contextual information of entities in text for entity linking. In one embodiment, the knowledge graph algorithm determines the semantic consistency of an entity by analyzing the words, sentence structure, semantic roles, and other features around the entity.

With respect to relationship modeling, the knowledge graph algorithm defines how different entities within the system are connected or related to each other. In one embodiment, such entities are the data points (e.g., reasons for causing abnormal indicators, solutions for resolving abnormal indicators). Furthermore, in one embodiment, the knowledge graph algorithm then forms connections between the entities, describing how they interact with each other. In one embodiment, the knowledge graph algorithm describes the number of relationships that can exist between entities.

Examples of software tools utilized by root cause analyzer 226 to generate troubleshooting graph 229 using the knowledge graph algorithm to model data as discussed above, include, but are not limited to, Neo4j®, Amazon Neptune®, Microsoft® Azure Cosmos DB®, SpaCy®, NLTK, Relik®, etc.

In step 707, root cause analyzer 226 identifies the root cause of the abnormal indicator using data structure 225 of the log information and troubleshooting graph 229 as illustrated in FIG. 5.

As discussed above, referring to FIG. 5, data structure 225 (equivalent to data structure 302′) is utilized to identify the root cause of the abnormal indicator based on utilizing the information stored in such a data structure, such as the label 304 and log 305′ (reflecting the most informative data). Furthermore, troubleshooting graph 229 is utilized to quickly query the causes of the abnormal indicators.

When there is only one root cause for the abnormal indicator, the root cause is returned directly. However, an abnormal indicator may be caused by several reasons. As a result, in one embodiment, root cause analyzer 226 calculates the distance between log 305′ and K, where K is a reason for causing an abnormal indicator (A) found in troubleshooting graph 229. Based on analyzing troubleshooting graph 229 for an abnormal indicator identified in data structure 302′, root cause analyzer 226 calculates the distances (see element 501) between various reasons for causing such an abnormal indicator (e.g., K₀:A₀, K₁:A₀, . . . . Kₙ:A₀). For example, root cause analyzer 226 calculates the distance between the root cause K₀ for causing abnormal indicator A₀ as well as calculates the distance between the root cause K₁ for causing abnormal indicator A₀ and so forth. Such distances are based on the distances between such causes and the abnormal indicator as graphed in troubleshooting graph 229.

In one embodiment, such calculations correspond to the distance |M₀′, K| 502, which is then sorted based on the distance from shortest to largest as shown in element 503. The smallest distance corresponds to the root cause for the abnormal indicator. A formula for calculating the distance between log 305′ and K is provided below.

distance

$$\vert {M}_{i}^{′} , {K}_{i} \vert = \frac{{M}_{i}^{′} \cdot {K}_{i}}{‖ {M}_{i}^{′} ‖ \times ‖ {K}_{i} ‖} .$$

In one embodiment, root cause analyzer 226 identifies the root cause of the abnormal indicator using data structure 225 of the log information and troubleshooting graph 229 as discussed above using various software tools, including, but not limited to, Splunk®, Elastic Slack (ELK®), Sumo Logic®, Datadog®, Prometheus®, Grafana®, etc.

In one embodiment, root cause analyzer 226 stores the list of root causes for the abnormal indicator into repository 221.

In step 708, handler 231 retrieves the corresponding recovery command 232 from command repository 221, which is then implemented.

As discussed above, the “corresponding recovery command,” as used herein, refers to the recovery command associated with the identified root cause of the abnormal indicator that was identified by root cause analyzer 226. A “recovery command,” as used herein, refers to a system command to resolve the cause of the abnormal indicator in operational data collector 201.

In one embodiment, command repository 221 stores a listing of recovery commands 232 associated with the root causes of abnormal indicators. In one embodiment, command repository 221 is populated by an expert. Upon root cause analyzer 226 identifying a root cause of the abnormal indicator, handler 231 performs a search in command repository 221 for recovery command 232 associated with the identified root cause of the abnormal indicator.

Referring to FIG. 7B, in conjunction with FIGS. 1-5, in step 709, handler 231 determines if recovery command 232 successfully resolved the abnormal indicator. That is, handler 231 determines if recovery command 232 restores the health of the component of operational data collector 201 associated with the abnormal indicator (see element 233).

As stated above, in one embodiment, handler 231 determines if recovery command 232 successfully resolved the abnormal indicator by monitoring system behavior of operational data collector 201 after running the recovery command to determine if the issue has been resolved. In one embodiment, handler 231 reviews logs or specific output from recovery command 232 to determine if the issue has bene resolved.

If recovery command 232 resolved the abnormal indicator, then, in step 710, handler 231 restores the health status of the component in operational data collector 201 associated with the abnormal indicator (see element 234).

If, however, recovery command 232 does not resolve the abnormal indicator, then, in step 711, handler 231 issues a message to user 228 (e.g., user of computer 101) regarding not resolving the abnormal indicator (see element 235).

Furthermore, if the recovery command does not resolve the abnormal indicator, then user 228 may proceed to resolve the abnormal indicator manually. As a result, in step 712, the corresponding recovery command used to resolve the abnormal indicator is then added to command repository 221 to be used in the future to resolve the corresponding abnormal indicator (see element 236). Furthermore, in one embodiment, such a recovery command is added to troubleshooting data 227 (see element 237) to retrain and generate troubleshooting graph 229 as discussed above.

In this manner, the root cause for abnormal indicators in the operational data collector can be accurately and quickly identified as well as addressed.

Furthermore, the principles of the present disclosure improve the technology or technical field involving operational data collectors.

As discussed above, operational data collectors gather and stream operational data from a system (e.g., z/OS® system) to various analytics platforms. One example of an operational data collector corresponds to IBM Z® Common Data Provider (ZCDP). ZCDP is a tool that collects, filters, and formats information technology (IT) operational data from z/OS® systems and streams it to analytics platforms. ZCDP can collect a variety of data types, including, but not limited to, System Management Facilities (SMF) data, IBM® Information Management System (IMS) logs, SYSLOG (z/OS® system log), and other z/OS® logs, such as job logs (file that records a job's execution details, including the commands used in the job, the start and end times of the job, any error messages or failure notices, system messages from the batch container, output from the job executables, etc.), and application logs (records created by software applications during their runtime, capturing details about events, user interactions, system errors, and other activities within the application). ZCDP can stream data to a number of destinations, including, but not limited to, IBM Z® Operations Analytics, Logstash® (Elasticsearch®), and Splunk®, ZCDP can collect data once and provide it to multiple subscribers, which can be analytic solutions. It can also filter data to target specific use cases and reduce data volumes. ZCDP contains many components performing various different functions, such as the system data engine (SDE), which is responsible for collecting operational data from various z/OS® systems, including system logs, performance metrics, and other relevant data sources. Another component of ZCDP is the data streamer (DS), which streams data from the data gatherers to configured subscribers in the appropriate format. During the operation of the ZCDP, an error message may be generated from an abnormal indicator. An indicator refers to a specific metric or status flag that displays information about the process being performed by the ZCDP, such as the data collection process. For example, indicators may indicate the number of records gathered, the data streaming rate, potential errors encountered, overall heath of the data stream being sent to a designated analytics platform, etc. At times, such indicators are “abnormal.” An abnormal indicator refers to an abnormal situation being detected, where an abnormal situation refers to a condition that significantly deviates from its expected or “normal” operating behavior. The result of an abnormal indicator is the issuance of an error message. Examples of causes of such error messages include an SDE that is broken, an SDE that did not receive data, the failure in starting up an SDE, etc. Unfortunately, it is difficult to identify the root cause of an abnormal indicator in the operational data collector. Examples of root causes of abnormal indicators include network abnormalities, processor overload, errors in the components, delays in sending data, etc., which takes developers a long time to identify such root causes. For instance, in order to identify the root cause of an abnormal indicator in the operational data collector, one needs to troubleshoot component by component of the ZCDP involved in the process. Furthermore, the logs (record of activities, operations, and usage patterns) of such components need to be analyzed which is a very complex and difficult process. Consequently, it is difficult to accurately and quickly identify the root cause for such abnormal indicators in the operational data collector, such as the ZCDP.

Embodiments of the present disclosure improve such technology by receiving an error message or a prediction of an error message pertaining to an abnormal indicator. Log information from a component of the operational data collector associated with the error message is then received and transformed into a data structure using the joint entropy of information theory. Furthermore, troubleshooting data, which includes reasons for causing abnormal indicators, listing of abnormal indicators, and solutions for addressing abnormal indicators, is also received. A graph (referred to herein as the “knowledge graph”) is then generated from the troubleshooting data using a knowledge graph algorithm to model the data. As discussed above, a knowledge graph, as used herein, is a representation of nodes representing an abnormal indicator, the reasons for causing the abnormal indicator, the solutions for addressing the abnormal indicator, and the relationships between the nodes. Furthermore, a root cause of the abnormal indicator is identified using the data structure of the log information and the knowledge graph. In one embodiment, the root cause is determined by identifying the smallest distance between the abnormal indicator in question and the reason for causing the abnormal indicator in question from the knowledge graph. A recovery command associated with the identified root cause of the abnormal indicator is then retrieved from a repository and implemented. In this manner, the root cause for abnormal indicators in the operational data collector can be accurately and quickly identified as well as addressed. Furthermore, in this manner, there is an improvement in the technical field involving operational data collectors.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method comprising:
receiving an error message or a prediction of an error message pertaining to an abnormal indicator;
receiving log information from a component of an operational data collector associated with said error message;
transforming said log information into a data structure using joint entropy of information theory;
receiving troubleshooting data, including reasons for abnormal indicators, listing of abnormal indicators, and solutions for addressing abnormal indicators;
generating a graph from said troubleshooting data using a knowledge graph algorithm to model data;
identifying a root cause of said abnormal indicator using said data structure of log information and said graph; and
retrieving and implementing a recovery command associated with said identified root cause of said abnormal indicator.

2. The method as recited in claim 1 further comprising:
issuing a message to a user regarding not resolving said abnormal indicator in response to said recovery command not resolving said abnormal indicator.

3. The method as recited in claim 2 further comprising:
adding a recovery command used to resolve said abnormal indicator to a repository of recovery commands and to said troubleshooting data.

4. The method as recited in claim 1 further comprising:
restoring a health status of said component of said operational data collector in response to said recovery command resolving said abnormal indicator.

5. The method as recited in claim 1 further comprising:
monitoring changes in environmental indicators; and
identifying changes in a health status of components of said operational data collector that exceed a threshold value within a period of time based on an indicator change.

6. The method as recited in claim 5 further comprising:
training an autoregressive model using said identified changes in said health status of said components of said operational data collector that exceed said threshold value within said period of time to predict a future health status of said components of said operational data collector.

7. The method as recited in claim 1 further comprising:
converting said troubleshooting data into structured data; and
generating said graph from said structured data using said knowledge graph algorithm to model data.

8. A computer program product comprising:
one or more computer readable storage media; and
program instructions stored on the one or more computer-readable storage media to perform operations comprising:
receiving an error message or a prediction of an error message pertaining to an abnormal indicator;
receiving log information from a component of an operational data collector associated with said error message;
transforming said log information into a data structure using joint entropy of information theory;
receiving troubleshooting data, including reasons for abnormal indicators, listing of abnormal indicators, and solutions for addressing abnormal indicators;
generating a graph from said troubleshooting data using a knowledge graph algorithm to model data;
identifying a root cause of said abnormal indicator using said data structure of log information and said graph; and
retrieving and implementing a recovery command associated with said identified root cause of said abnormal indicator.

9. The computer program product as recited in claim 8, wherein the operations further comprise:
issuing a message to a user regarding not resolving said abnormal indicator in response to said recovery command not resolving said abnormal indicator.

10. The computer program product as recited in claim 9, wherein the operations further comprise:
adding a recovery command used to resolve said abnormal indicator to a repository of recovery commands and to said troubleshooting data.

11. The computer program product as recited in claim 8, wherein the operations further comprise:
restoring a health status of said component of said operational data collector in response to said recovery command resolving said abnormal indicator.

12. The computer program product as recited in claim 8, wherein the operations further comprise:
monitoring changes in environmental indicators; and
identifying changes in a health status of components of said operational data collector that exceed a threshold value within a period of time based on an indicator change.

13. The computer program product as recited in claim 12, wherein the operations further comprise:
training an autoregressive model using said identified changes in said health status of said components of said operational data collector that exceed said threshold value within said period of time to predict a future health status of said components of said operational data collector.

14. The computer program product as recited in claim 8, wherein the operations further comprise:
converting said troubleshooting data into structured data; and
generating said graph from said structured data using said knowledge graph algorithm to model data.

15. A computer system comprising:
a processor set;
one or more computer-readable storage media; and
program instructions stored on the one or more computer-readable storage media to cause the processor set to perform operations comprising:
receiving an error message or a prediction of an error message pertaining to an abnormal indicator;
receiving log information from a component of an operational data collector associated with said error message;
transforming said log information into a data structure using joint entropy of information theory;
receiving troubleshooting data, including reasons for abnormal indicators, listing of abnormal indicators, and solutions for addressing abnormal indicators;
generating a graph from said troubleshooting data using a knowledge graph algorithm to model data;
identifying a root cause of said abnormal indicator using said data structure of log information and said graph; and
retrieving and implementing a recovery command associated with said identified root cause of said abnormal indicator.

16. The computer system as recited in claim 15, wherein the operations further comprise:
issuing a message to a user regarding not resolving said abnormal indicator in response to said recovery command not resolving said abnormal indicator.

17. The computer system as recited in claim 16, wherein the operations further comprise:
adding a recovery command used to resolve said abnormal indicator to a repository of recovery commands and to said troubleshooting data.

18. The computer system as recited in claim 15, wherein the operations further comprise:
restoring a health status of said component of said operational data collector in response to said recovery command resolving said abnormal indicator.

19. The computer system as recited in claim 15, wherein the operations further comprise:
monitoring changes in environmental indicators; and
identifying changes in a health status of components of said operational data collector that exceed a threshold value within a period of time based on an indicator change.

20. The computer system as recited in claim 19, wherein the operations further comprise:
training an autoregressive model using said identified changes in said health status of said components of said operational data collector that exceed said threshold value within said period of time to predict a future health status of said components of said operational data collector.
